(19) United States
(12) Patent Application Publication
(10) Pub. No.: US 2023/0249271 A1
(43) Pub. Date: Aug. 10, 2023

(54) REAMERS AND METHODS OF PREPARING TUBING

(71) Applicant: Titeflex Corporation, Springfield, MA (US)

(72) Inventor: Jordan Strunk, Portland, TN (US)

(73) Assignee: Titeflex Corporation, Springfield, MA (US)

(21) Appl. No.: 18/164,360

(22) Filed: Feb. 3, 2023

Related U.S. Application Data
(60) Provisional application No. 63/308,202, filed on Feb. 9, 2022.

(51) Int. Cl. B23D 77/12; B23B 5/16

(52) U.S. Cl. CPC B23D 77/12; B23B 5/168; B23D 2277/2464

(57) ABSTRACT

One aspect of the invention provides an injection-molded reamer including: an injection-molding parting line; and one or more shafts having a maximum cross-sectional dimension and a length-to-maximum-cross-sectional-dimension aspect ratio of 1:1 or greater. Each of the one or more shafts includes either: (A) one or more axial cross profiles including: a first bar having the maximum cross-sectional dimension; and a second bar having a cross-sectional dimension less than the maximum cross-section dimension, wherein the second bar is parallel to the injection-molding parting line; or (B) one or more axial elliptical profiles including: a major axis having the maximum cross-sectional dimension; and a minor axis having a cross-sectional dimension less than the maximum cross-section dimension, wherein the minor axis is parallel to the injection-molding parting line.

### CROSS-REFERENCE TO RELATED APPLICATION

This application claims the benefit of priority to U.S. Provisional Pat. Application Serial No. 63/308,202, filed Feb. 9, 2022. The entire content of this application is hereby incorporated by reference herein.

### BACKGROUND OF THE INVENTION

Various types of tubing are provided in coiled form to facilitate long runs with minimal seams. Although such tubing, and the fittings applied to ends, are designed to have an annular profile, coiling of tubing tends to yield an oval profile, which can interfere with the tubing connecting to fittings.

### SUMMARY OF THE INVENTION

One aspect of the invention provides an injection-molded reamer including: an injection-molding parting line; and one or more shafts having a maximum cross-sectional dimension and a length-to-maximum-cross-sectional-dimension aspect ratio of 1:1 or greater. Each of the one or more shafts includes either: (A) one or more axial cross profiles including: a first bar having the maximum cross-sectional dimension; and a second bar having a cross-sectional dimension less than the maximum cross-section dimension, wherein the second bar is parallel to the injection-molding parting line; or (B) one or more axial elliptical profiles including: a major axis having the maximum cross-sectional dimension; and a minor axis having a cross-sectional dimension less than the maximum cross-section dimension, wherein the minor axis is parallel to the injection-molding parting line.

This aspect of the invention can have a variety of embodiments. The injection-molded reamer can further include: a plurality of the one or more shafts; and a central hub coupled to each of the plurality of the one or more shafts. The plurality of the one or more shafts can be selected from the group consisting of: 2, 3, and 4.

The injection-molded reamer can include three shafts. The maximum cross-sectional dimension for the three shafts can be: about 0.19” (about 4.8 mm); about 0.311” (about 7.90 mm); and about 0.436” (about 11.1 mm).

The injection-molded reamer can include three shafts. The maximum cross-sectional dimension for the three shafts can be: about 0.555” (about 14.1 mm); about 0.68” (about 17.3 mm); and about 0.785” (about 19.9 mm).

The injection-molded reamer can include one or more selected from the group consisting of: a polymer and an alloy. The polymer can be selected from the group consisting of: a thermoplastic polymer, a thermoset polymer, an elastomer, a composite, and a fiber-reinforced polymer. The polymer can be selected from the group consisting of: epoxy, phenolic resin, nylon, nylon 6 (polyamide 6 or polycaprolactam), glass-fiber-reinforced nylon 6, polyethylene, and polystyrene.

The injection-molded reamer can further include one or more chamfering blades at a proximal base of each of the one or more shafts.

The one or more shafts can further include a tapered distal end. The tapered distal end can be an elliptical tapered distal end.

The injection-molded reamer can further include a tubing-support member at least partially surrounding at least one of the one or more shafts

Another aspect of the invention provides a method of preparing polymer tubing bent out-of-round for coupling with a fitting. The method includes: aligning an appropriately sized one of the shafts of the injection-molded reamer as described herein with an end of the polymer tubing such that the maximum cross-sectional dimension of the shaft is substantially aligned with a maximum cross-sectional dimension of the tubing; advancing the aligned shaft into an inner bore of the end of the polymer tubing; and rotating the aligned shaft within the inner bore of the end of the polymer tubing.

This aspect of the invention can have a variety of embodiments. The polymer tubing can be selected from the group consisting of: PEX-A1-PEX and PERT-Al-PERT. The polymer tubing can have been previously coiled.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1A (including FIG. 1A-1) and FIG. 1B (including FIG. 1B-1) depict embodiments of reamers according to embodiments of the invention.

FIG. 2 depicts a method of preparing tubing bent out-of-round for coupling with a fitting according to an embodiment of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

As used in the specification and claims, the term “ellipse” can include both mathematical definition as well as oblong shapes such as a stadium and a superellipse.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., where the entry point is distal from the user.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Multilayer composite tubes can be fabricated from multiple layers of material including various plastics, adhesives and, in some cases metal layers. Exemplary constructions for multilayer composite tubes are summarized below.

TABLE 1

Exemplary Multilayer Composite Pipe Constructions

| | |
|---|---|
| Short Name | Components |
| PE/AL/PE | Polyethylene / Aluminum / Polyethylene |
| PEX/AL/PEX | Cross-linked Polyethylene / Aluminum / Cross-linked Polyethylene |
| PERT/AL/PERT | Polyethylene of raised temperature / Aluminum / Polyethylene of raised temperature |

A variety of multilayer composite tubes and applications for the same are described in U.S. Pat. Application Publication No. 2020/0400251.

The composite tubes described above can be used for a variety of applications. For example, the composite tubes can be used for common water conveyance applications. However, there are many other applications for which this type of tube can be used. These other applications could include the conveyance of other types of liquids and gases such as refrigerants, natural gas, propane, and process and medical gases such as argon, helium, nitrogen, and the like.

Composite tubes can also be utilized in a refrigeration system, such as an air conditioning system. The refrigeration system can be configured to act as a heat pump that extracts heat from air surrounding the condenser coil and transfers that heat to the evaporator coil to heat a structure. The refrigeration system can include a suction line and a return line.

In one embodiment, multilayer composite tubes can be utilized as line sets for a refrigeration or air conditioning system carrying a flammable (e.g., slightly flammable or highly flammable) refrigerant.

### Reamers

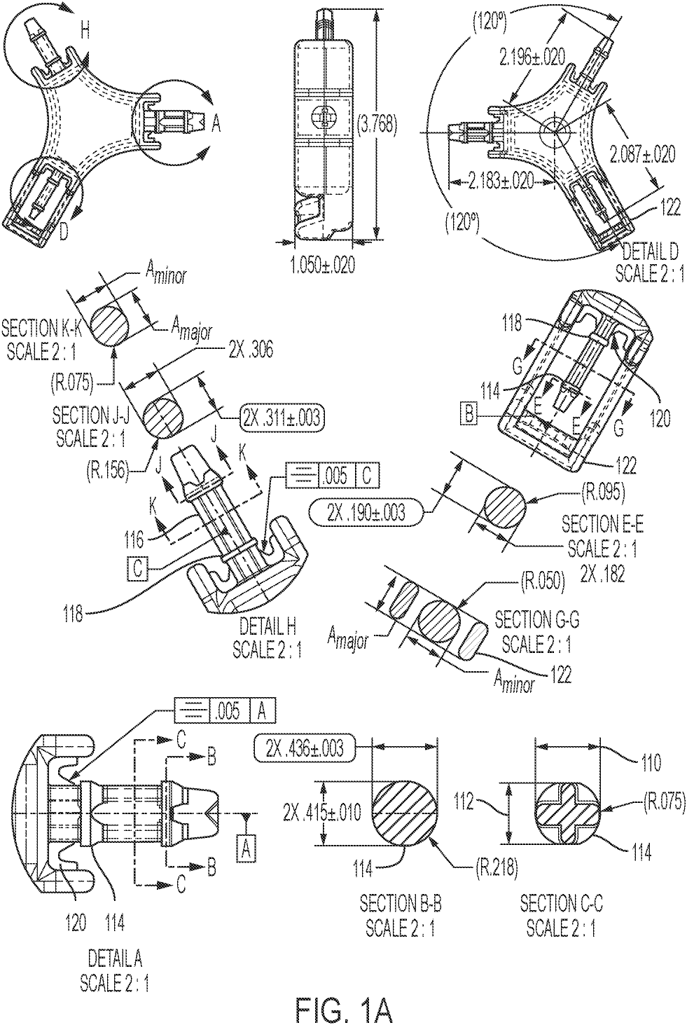

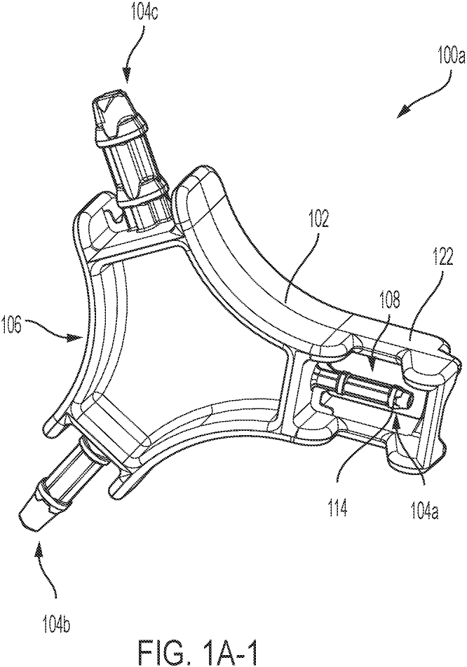

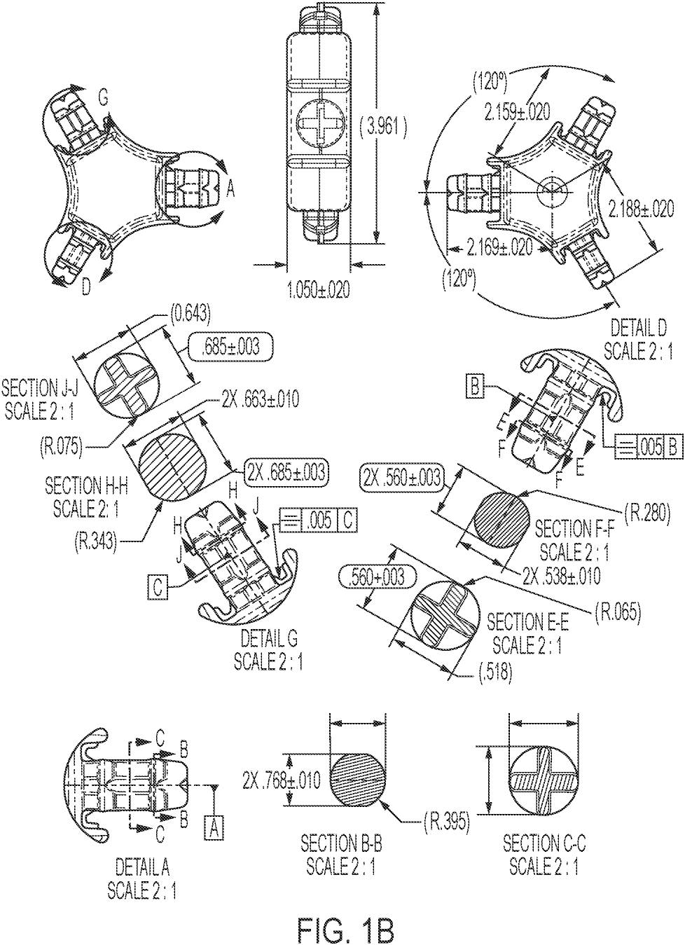

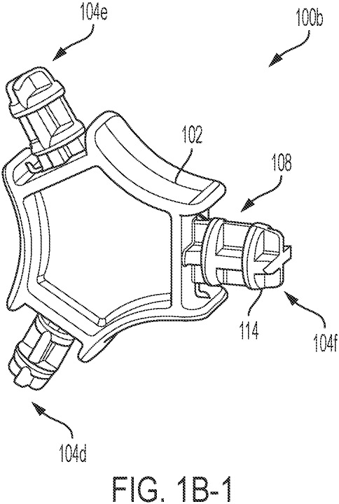

Referring now to FIG. 1A, embodiments of the present disclosure provide reamers 100a that are useful in preparing tubing for coupling to a fitting. The reamer 100a can be economically produced using injection molding, in which two halves of a mold are pressed together and a molten material is injected within a cavity defined by the mold. Excess material known as flash or flashing may form along the parting line 102 where the two surfaces of the mold meet (e.g., to the leakage). Various deflashing techniques can be utilized after molding to remove flash, which adds to manufacturing costs. Embodiments of the present disclosure provide reamers with oblong profiles that better reflect the geometry of previously-coiled tubing, minimize the need for deflashing, and can be formed in a single-direction-pull injection mold.

Oblong reamers are easier to insert into tubing that is out of round (e.g., from coiling). The ability to reliably restore tubing to an annular profile allows for fittings to be manufactured to a tighter tolerance relative to the inner bore of the tubing, which in turn, requires less compressive force from a fitting in order to achieve a seal.

The embodiments of the reamers 100a and 100b depicted in FIGS. 1A and 1B, respectively, include three shafts 104a-104c arranged at 120° intervals about a central hub 106. The shafts 104a-104c can have different structures, which can be influenced by the size of the respective shaft 104a-104c. As used herein, each shaft 104a-104c is configured to have a maximum cross-sectional dimension, e.g., which can equal or be slightly less than an inner diameter of the corresponding tubing for which the shaft 104a-104c is specified. Nominal and actual ACR copper tubing dimensions are provided in Table 2 below.

TABLE 2

ACR Copper Pipe Sizes

| | | | | | | | |
|---|---|---|---|---|---|---|---|
| Pipe Identification | ¼″ | ⅜″ | ½″ | ⅝″ | ¾″ | ⅞″ | 1⅛″ |
| Outer Diameter | 0.25″ | 0.375″ | 0.5″ | 0.625″ | 0.75″ | 0.875″ | 1.125″ |
| Inner Diameter | 0.19″ (∼4.8 mm) | 0.311″ (∼7.90 mm) | 0.436″ (∼11.1 mm) | 0.555″ (∼14.1 mm) | 0.68″ (∼17.3 mm) | 0.785″ (∼19.9 mm) | 1.025″ (∼26.04 mm) |

One embodiment of a shaft 104c includes one or more axial cross profiles 108. The axial cross profile 108 includes a first bar 110 and a second bar 112 that intersect with each other, e.g., perpendicularly. The first bar 110 can have the maximum cross-sectional dimension for that shaft 104c. The second bar 112 can have a cross-sectional dimension less than the maximum cross-section dimension. The first bar 110 can be perpendicular to the plane defined by the parting line 102. The second bar 112 can be parallel to and lie in the plane defined by the parting line 102. Advantageously, any swarf, chips, or cuttings can gather in the recesses defined by the axial cross profile(s) 108, in particular the proximal region closest to the central hub 106.

Shaft 104c can optionally include one or more elliptical ribs 114 along the shaft. As seen in FIG. 1A, Section C-C, the dimensions of the elliptical ribs can track the dimensions of the first bar 110 and the second bar 112. The ribs 114 can pull swarf from the inner bore of the tubing when withdrawn.

Another embodiment of a shaft 104a, 104b is particularly useful for smaller diameter tubing (e.g., ¼″ and ⅜″ nominal tubing) for which the cross geometry may not provide sufficient torsional strength and where the smaller-sized shafts can be injection molded as a solid piece. In this embodiment, the shafts 104a, 104b can have one or more axial elliptical profiles 116. The axial elliptical profiles 116 can include a major axis Aₘₐⱼₒᵣ having the maximum cross-sectional dimension and a minor axis Aₘᵢₙₒᵣ having a cross-sectional dimension less than the maximum cross-section dimension. The major axis Aₘₐⱼₒᵣ can be perpendicular to the plane defined by the parting line 102. The minor axis Aₘᵢₙₒᵣ can be parallel to and lie in the plane defined by the parting line 102. The shafts 104a, 104b can also include one or more ribs 118 having a larger cross-sectional profile. For example, ribs 118 can have a circular axial profile with a diameter equal to the maximum cross-sectional dimension for that shaft 104a, 104b. (Deflashing may be desired for the circular ribs 118, but could be specified only for these features.)

Still referring to FIG. 1A, one or more shafts (e.g., smaller shafts such as 104a) can optionally include a pipe-support feature 122 that can provide external support to the tubing (e.g., to prevent during insertion). The pipe-support feature 122 can also protect smaller shafts (e.g., 104a) from damage.

Shafts 104a-104c can also include one or more chamfering blades 120 at a proximal base of the shaft 104a-104c.

The shafts can also have tapered distal ends, which ease insertion into the inner bore and can push open an inner lip that can be formed when using a pipecutter with a rotating wheel. The tapered distal ends can have an elliptical profile (e.g., regardless of whether the rest of the shaft has a cross or an elliptical profile). Without being bound by theory, Applicant believes that an elliptical tapered end requires lower force for insertion and rotation than an equivalent annular tapered end, likely due to a reduction of surface area in contact with the inner bore of the tubing.

FIG. 1B depicts another embodiment of a reamer 100b designed for use with larger diameter tubing. Each of shafts 104d-104f has the axial cross profile described in the context of shaft 104c.

### Materials

Reamers 100a, 100b can be fabricated from a variety of materials suitable to injection molding including metals (e.g., alloys) and polymers (e.g., thermoplastic polymers, thermoset polymers, elastomers, composites, and fiber-reinforced polymers). Preferably, the material selected will be drop-resistant, particularly in unheated cold-weather environments and wear-resistant relative to PEX and PERT. Exemplary polymers include epoxy, phenolic resin, nylon, nylon 6 (polyamide 6 or polycaprolactam), glass-fiber-reinforced nylon 6 (e.g., PA6GF33HI), polyethylene, and polystyrene.

### Methods of Use

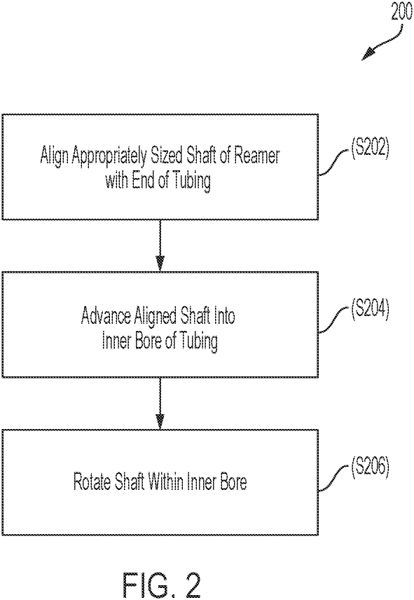

Referring now to FIG. 2, another aspect of the disclosure provides a method 200 of preparing tubing bent out-of-round for coupling with a fitting.

In step S202, an appropriately sized one of the shafts of an injection-molded reamer is aligned with an end of the polymer tubing such that the maximum cross-sectional dimension of the shaft is substantially aligned with a maximum cross-sectional dimension of the tubing.

In step S204, the aligned shaft is advanced into an inner bore of the end of the tubing.

In step S206, the aligned shaft is rotated within the inner bore of the end of the tubing.

The end of the tubing can be angled down toward the ground so that any swarf, chips, or cuttings fall toward the end of the tubing and fall out when the shaft is removed.

The tubing can be polymer tubing such as PEX, PEX-Al-PEX, PERT-Al-PERT, and the like. The tubing may have been previously coiled.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. An injection-molded reamer comprising:
an injection-molding parting line; and
one or more shafts having a maximum cross-sectional dimension and a length-to-maximum-cross-sectional-dimension aspect ratio of 1:1 or greater, each of the one or more shafts comprising either:
(A) one or more axial cross profiles comprising:
a first bar having the maximum cross-sectional dimension; and
a second bar having a cross-sectional dimension less than the maximum cross-section dimension;
wherein the second bar is parallel to the injection-molding parting line; or
(B) one or more axial elliptical profiles comprising:
a major axis having the maximum cross-sectional dimension; and
a minor axis having a cross-sectional dimension less than the maximum cross-section dimension;
wherein the minor axis is parallel to the injection-molding parting line.

2. The injection-molded reamer of claim 1, wherein the injection-molded reamer further comprises:
a plurality of the one or more shafts; and
a central hub coupled to each of the plurality of the one or more shafts.

3. The injection-molded reamer of claim 2, wherein the plurality of the one or more shafts is selected from the group consisting of: 2, 3, and 4.

4. The injection-molded reamer of claim 1, wherein:
the injection-molded reamer further comprises three shafts; and
the maximum cross-sectional dimension for the three shafts are:
about 0.19″ (about 4.8 mm);
about 0.311″ (about 7.90 mm); and
about 0.436″ (about 11.1 mm).

5. The injection-molded reamer of claim 1, wherein:
the injection-molded reamer further comprises three shafts; and
the maximum cross-sectional dimension for the three shafts are:
about 0.555″ (about 14.1 mm);
about 0.68″ (about 17.3 mm); and
about 0.785″ (about 19.9 mm).

6. The injection-molded reamer of claim 1, wherein the injection-molded reamer comprises one or more selected from the group consisting of: a polymer and an alloy.

7. The injection-molded reamer of claim 6, wherein the polymer is selected from the group consisting of: a thermoplastic polymer, a thermoset polymer, an elastomer, a composite, and a fiber-reinforced polymer.

8. The injection-molded reamer of claim 6, wherein the polymer is selected from the group consisting of: epoxy, phenolic resin, nylon, nylon 6 (polyamide 6 or polycaprolactam), glass-fiber-reinforced nylon 6, polyethylene, and polystyrene.

9. The injection-molded reamer of claim 1, further comprising:
one or more chamfering blades at a proximal base of each of the one or more shafts.

10. The injection-molded reamer of claim 1, wherein the one or more shafts further comprise a tapered distal end.

11. The injection-molded reamer of claim 1, wherein the tapered distal end is an elliptical tapered distal end.

12. The injection-molded reamer of claim 1, further comprising a tubing-support member at least partially surrounding at least one of the one or more shafts.

13. A method of preparing polymer tubing bent out-of-round for coupling with a fitting, the method comprising:
aligning an appropriately sized one of the shafts of the injection-molded reamer according to claim 1 with an end of the polymer tubing such that the maximum cross-sectional dimension of the shaft is substantially aligned with a maximum cross-sectional dimension of the tubing;
advancing the aligned shaft into an inner bore of the end of the polymer tubing; and
rotating the aligned shaft within the inner bore of the end of the polymer tubing.

14. The method of claim 13, wherein the polymer tubing is selected from the group consisting of: PEX-Al-PEX and PERT-Al-PERT.

15. The method of claim 13, wherein the polymer tubing was previously coiled.
